(19) United States
(12) Patent Application Publication
(10) Pub. No.: US 2004/0141003 A1
(43) Pub. Date: Jul. 22, 2004

(54) Maintaining a user interest profile reflecting changing interests of a customer

(75) Inventors: Morton Davis Nivers, Newport, RI (US); Steven M. Saxon, Austin, TX (US)

Correspondence Address: BAKER BOTTS, LLP, 910 LOUISIANA, HOUSTON, TX, 77002-4995, US

(73) Assignee: DELL PRODUCTS, L.P.

(21) Appl. No.: 10/347,974

(22) Filed: Jan. 21, 2003

(51) Int. Cl. G09G 5/00

(52) U.S. Cl. 345/745

(57) ABSTRACT

A method and system that establishes, maintains and automatically updates a user interest profile according to information most recently requested by the user. The user profile can be represented as a single set of n coordinates. The set of n coordinates identifies a position within an n-dimensional space that represents a spectrum of topics of interest. The position of the set of n coordinates in the n-dimensional space represents a user's level of relative interest in the topics represented in the spectrum and is updated according to information requested by the user.

Portions of this patent application contain materials that are subject to copyright protection. The copyright owner has no objection to the facsimile reproduction by anyone of the patent document, or the patent disclosure, as it appears in the Patent and Trademark Office file or records, but otherwise reserves all copyright rights whatsoever.

### BACKGROUND OF THE INVENTION

As the value and use of information increases, individuals and businesses seek additional ways to process and store information. One option available to these individuals and businesses is to use information-handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled; how the information is handled; how much information is processed, stored, or communicated; and how quickly and efficiently the information can be processed, stored, or communicated.

The variations in information handling systems allow them to be configured as general purpose systems, for a specific user, or for a specific use such as financial transaction processing, airline reservations, enterprise data storage, or global communications. In addition, information-handling systems may include a variety of hardware and software components that may be configured to process, store, and communicate information and may include one or more computer systems, data storage systems, and networking systems.

In today's business environment, many customers and potential customers are familiar with using information-handling systems to obtain information about goods and services. For example, many individuals access the Internet, also referred to as the World-Wide Web or the web, on a regular basis to search for information about available products and services.

In the context of the Internet, businesses have established web sites to offer goods and services to customers using client information handling systems, such as personal computers, coupled to the Internet. A web site can be thought of as a virtual business location (i.e., one that lacks the brick and mortar of a physical business location) and is a collection of one or more web pages. Typically, a person using a client information handling system requests information using web browser software such as Microsoft Internet Explorer or Netscape Navigator. A server information handling system, including web server software such as Microsoft Internet Information Server, provides a response including the information to the client information handling system in the form of a web page.

Each web page is a distinct document having its own Internet address, called a Uniform Resource Locator (URL). Each web page can incorporate various multimedia resource components including text, graphics, animation, video images and sounds, including music and speech. Web pages that include sound and video components can be heard and seen when the client information handling system includes the hardware and software necessary to support audio and video presentation via the browser. Web pages are often linked together using hypertext links.

A hypertext link is a tag or string of text that implicitly points to another URL. When selected by the user, the link can cause the client browser to retrieve a different document or other resource that is related to the document in which the link is embedded. Moreover, documents can be constructed of resources that might be located in a completely different server than the one containing the document itself. In this case, the browser, upon receipt of the HTML document, recognizes that one or more resources are located elsewhere and retrieves them from their respective locations.

When selected by the user, links direct the browser to request the other web page from a web server. In an embodiment of the invention not including the Internet, other types of requests for content can be similarly made.

The web pages of a multiple-page web site are often hierarchically organized as a tree structure using the links, with each branch representing some category or subcategory of information. Less sophisticated web sites can also be organized linearly or even randomly. The term “home page” typically refers to the top (tree structure) or first (linear or random) web page of a web site. The home page typically acts as an introduction to the web site, explaining its purpose and describing the information found on the other web pages making up the web site. In this way, the home page acts as an index, or table of contents, for the rest of the web site.

The tree structure can be useful to businesses that sell many different categories of products and/or services. The home page for a purveyor of computers might, for example, sell desktop computers configured differently for personal use versus those configured for business applications. The business may also sell laptop computers, computers with higher cost and performance for use as servers, etc. Thus, the home page could provide hypertext links to additional web pages that provide information regarding each class of products, as well as to customer service information, background information concerning the company, contact information (e.g. telephone numbers and e-mail addresses), computer accessories, and so forth. Each initial or top web page for a category can have additional links, including one leading back to the home page, one leading to more specific information concerning products falling under the category, and so on.

To facilitate commercial transactions, information about a user is often maintained by the web server. For example, when a user subscribes to a service or purchases a product over the Internet, the subscription or purchase information associated with that user may be retained. This retained information enables the user to input the purchase or subscription information only once, thereby allowing the user to access the subscribed service or to make a purchase from that particular web site without re-entering the subscription or purchase information.

One technique to retain such information is to generate a piece of data (often referred to as a state object or cookie) that uniquely identifies the user. A web server returns the cookie along with the web server's response to a client request for a particular web page or content, such as a subscribed service or information concerning a product purchase. Upon subsequent requests to access the same URL by the user, the cookie is sent back to the server along with the client request. The server can then verify that the user is a subscriber of the service or already has a purchase profile retained by the product supplier. The cookie eliminates the need for the user to re-subscribe or to re-enter the same purchase information. The cookie is a relatively small amount of data and is designed to be a pointer (unique to the user) into a subscription or customer profile database to which the server has access. The server uses the cookie to access and retrieve the customer profile or subscription information and sometimes returns the retrieved information to the user for verification. For more background information regarding how cookies can be created, formatted and sent between the server and client, refer to U.S. Pat. No. 5,875,296.

A profile of a user's interests, referred to herein as a user profile, can be maintained for the purpose of targeting specific information (e.g., product pricing and marketing) to the user. Otherwise, the user may not receive marketing information in which he or she has a keen interest. A user can be intimidated or frustrated with information irrelevant to the customer's interests, and a sale might be lost to a competitor as a result.

Internet Service Providers (ISPs), also referred to herein as service providers, maintain customer profiles. ISPs typically provide a home page that is retrieved by a user upon connection to the Internet through the service. Because many service providers offer their services over wide geographic areas, some service providers allow their users to customize their home pages. For example, a user can specify that the home page should display information of specific interest to the user, such as weather for the city in which the user resides, or prominent headlines in sports of interest, possibly limited to specific sports or specific teams. The home page can also provide updated stock quotes for stocks of interest to the user. The user profile used to customize the home page is typically created by the user responding to queries from the server regarding the user's interests. These interests are stored as a profile in association with the server, and the home page is constructed in accordance with the profile every time the user logs onto the Internet through the service provider.

Another simple example of profiling has been used in conjunction with web sites offering a number of categories of products. The web site provides a list of customer type categories and asks the user to place himself or herself into one of those categories. The web site then uses the category selected by the user to provide targeted content to the user based on the user's selection. There are several significant shortcomings of this approach however. First, a customer may not know or understand the type of customer he or she might be. Second, a customer may not fit neatly into any one category and therefore may be unable to choose a particular category that he or she believes is appropriate. Third, a customer may select a category that the customer feels he or she most closely fits, but the selection may lead to content being displayed for products other than those that the customer visited to the web site to purchase. Finally, a user may not realize that it was the user's choice of customer category that caused this irrelevant product information to be displayed and may go to a competitor's web site when not immediately successful in obtaining pertinent information.

Some web sites allow a user to assign rankings, or percentages, to categories to address these problems. However, it may be even more difficult for a user to assign percentages to multiple categories. Furthermore, some categories may have many sub-categories, increasing the amount of data that must be maintained for each user and the complexity of establishing and maintaining a user profile.

Another profiling technique involves the use of an automated profiling software program associated with the server of a service provider or web site. The program is invoked uniquely for each user logging into a particular service provider or web site. The program monitors the content requested and viewed by each user, advertisements selected by the user, and the total time such content was viewed during the current user session. The program then makes assumptions about the interests of a user, and based on these assumptions, controls the formatting, content and advertisements provided to the user in conjunction with any request for content made by the user. The state of the user profile is stored after the user logs off, and the user profile is invoked and continues to run from the previous state when the user logs on again. The program identifies each user by means of a cookie, as previously discussed.

Another similar approach involves a profiling program being downloaded directly to the client upon logging on, where the profiling program is run locally by the client. The program also keeps track of the user's session in a manner similar to the program residing with the server above, and then uploads the session information back to the server at the end of the session, where it is analyzed and a profile is created. The problem with the two foregoing prior art techniques of automatically profiling customer interests is that they are very complicated and can produce a very large volume of data that must be analyzed, stored, and interpreted to determine a customer's interests.

Those of skill in the art will recognize that there is a need for a user profiling technique that is automated and therefore requires only minimal information from the user. The user profiling technique should store and update data reflecting the user's interests in a concise manner, permit a controlled transition between categories, and recognize profiles that overlap or fall between defined categories. The user profiling technique should also be flexible as applied to the spectrum of interests that are to be profiled.

### SUMMARY OF THE INVENTION

The present invention relates to a method and system that establishes, maintains and automatically updates a user interest profile according to information most recently requested by the user. The user profile can be represented as a single set of n coordinates. The set of n coordinates identifies a position within an n-dimensional space that represents a spectrum of topics of interest. The position of the set of n coordinates in the n-dimensional space represents a user's level of relative interest in the topics represented in the spectrum.

In one feature of the invention, a method for presenting information to a user includes establishing a first user profile for the use within one or more categories of interest. The first user profile corresponds to a first category of the various categories. The next step of the method is to use the first category and the first information that is requested by the user to determine a second category of the various categories of interested to the user. Next, the consumer profile is adjusted to produce a second consumer profile for the user with the first category and the second category. Finally, the user is presented with a first set of information and a third set of information that correspond to a third category of the various categories that is formed using the first and second customer profiles. In some cases, the third category will fall between the first and second categories. In other cases, the third category will be the same as the first. In still other instances, the third category will be the same as the second category. In most cases, however, the first use profile will be moved toward the second category. A system, such as a personal computer or a server, may be used to implement the present invention, typically in a combination of hardware and/or software.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIG. 1 provides a conceptual illustration of an information handling system.

FIG. 2 is an example of categories of user interests mapped onto a circle for a web-based business selling computers.

FIG. 3 shows web content to be provided to a user with a user profile within a category identified by a segment of the circle of FIG. 2.

FIG. 4 shows the user has requested content that is significantly different than the category in which the user's profile currently resides.

FIG. 5 illustrates one embodiment of a function that may be used to determine movement of a user profile when information in a new interest area is requested.

FIG. 6 is a graph of the position of a user's profile as it moves from an initial position over time.

FIG. 7 shows a user profile positioned at a location identified by coordinates x, y and z in a three-dimensional space.

FIG. 8a shows an example of an implementation for determining a new location of a user profile for a particular user when the user has selected content falling into a category outside the category into which the user's profile currently falls.

FIG. 8b shows an example using a non-linear scaling factor for determining a new location of a user profile for a particular user when the user has selected a category outside the current user profile category.

FIG. 9a shows an alternative “zone of inclusion” approach for determining a new location of a user profile for a particular user when the user has selected a category outside the user's current category.

FIG. 9b illustrates a combination of the zone of inclusion approach and the inverse-square rule used to determine a new location of a user profile for a particular user when the user has selected content related to a category outside the category including the user profile's initial position.

FIG. 9c shows a user profile positioned within the jazz category and three jazz subcategories of FIG. 9a.

FIG. 9d shows scores that have been calculated for the user profile shown in FIG. 9c.

FIG. 10 shows an example calculation of a new position for a user profile in a polar coordinate system.

FIG. 11 shows a graph of position of the user profile with consecutive clicks on links of a web page corresponding to a target category. Superimposed is a graph of the velocity of the movement of the user profile with consecutive clicks.

The use of the same reference symbols in different drawings indicates similar or identical items. The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives and equivalents falling within the spirit and scope of the invention, as defined by the appended claims, are to be covered.

### DETAILED DESCRIPTION

The present invention relates to a method, system, and information handling system for presenting information to a user according to the user's interests. The method includes establishing a user profile for the user within multiple categories of interests so that the initial user profile corresponds to a first category. The method further includes dynamically using the initial category to determine a second category that interests the user according to information requested by the user. The method further includes adjusting the customer profile using the first category and the second category to produce a second customer profile. The method includes using the second customer profile for presenting to the user the requested information as well as information corresponding to a third category between the first and second categories.

The method and system of the present invention represents a user's profile of interests as a set of n coordinates identifying the customer's relative interest among a spectrum or universe of categories mapped into the n-dimensional space. The present invention allows the interests of customers to be profiled within a continuous spectrum of interest categories that transition from one to another in a continuous manner, or to be profiled with respect to various categories of interests. Moreover, the customer profile is permitted to smoothly move about this spectrum or universe of interests as a function of the customer's evolving interests as demonstrated by content requested by the customer.

For example, a user profile may indicate that the user is primarily interested in jazz music, but the user may request content regarding music by Mozart. Ideally, the system provides more information for music in categories related to Mozart, but does not suddenly shift away from the user's expressed interest in jazz.

Each piece of content can be marked with a set of coordinates that identifies the position of the content within the n-dimensional space. As the customer looks at content in different locations, the user's profile position is moved in the direction of the user's most recently expressed interests.

If a user expresses a shift in interests, such as a shift from jazz to Mozart, some intervening categories in the n-dimensional space may also be of interest, such as modern classics performed by artist Benjamin Britten. Such intervening content may be presented to the user, depending upon the arrangement of the categories within the n-dimensional space and the implementation for presenting content. Content presented to the user may vary between implementations.

Those of skill in the art will recognize that the term user and customer are often used interchangeably in this discussion, as most examples of embodiments are made for the purpose of targeting marketing or sales information to a potential customer. It should be noted that while a customer is always a user, a user is not necessarily a customer. An information provider may wish to target a user using the present invention with information that would interest that particular user and not intend to sell the user anything directly. A customer is a user that is potentially or presently a purchaser of goods and/or services. The present invention is not intended to be limited to only customers, but is intended to apply to users generally.

The invention is described in the context of a web-based business, although the invention is not so limited. The present invention may be implemented using a single information handling system or according to a client/server paradigm such as that of the web. In a client/server implementation, the information handling systems may be networked using a network other than the Internet and may use different protocols.

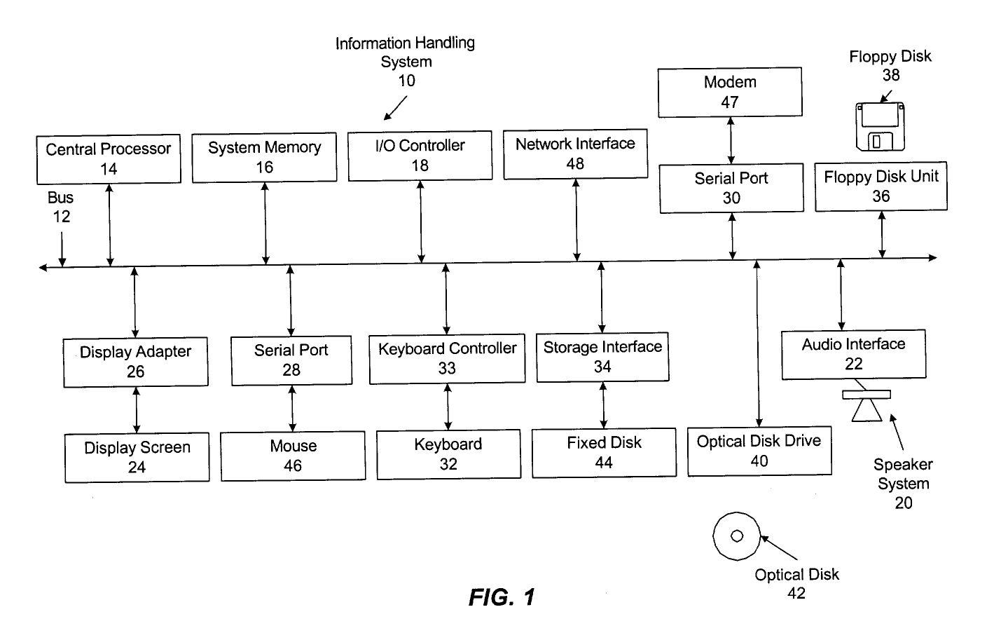

FIG. 1 provides a block diagram of an information handling system 10 suitable for implementing the present invention. Information handling system 10 includes a bus 12 which interconnects major subsystems of information handling system 10 such as a central processor 14, a system memory 16 (typically RAM, but which may also include ROM, flash RAM, or the like), an input/output controller 18, an external audio device such as a speaker system 20 via an audio output interface 22, an external device such as a display screen 24 via display adapter 26, serial ports 28 and 30, a keyboard 32 (interfaced with a keyboard controller 33), a storage interface 34, a floppy disk unit 36 operative to receive a floppy disk 38, and an optical disk drive 40 operative to receive an optical disk 42. Also included are a mouse 46 (or other point-and-click device, coupled to bus 12 via serial port 28), a modem 47 (coupled to bus 12 via serial port 30) and a network interface 48 (coupled directly to bus 12).

Bus 12 allows data communication between central processor 14 and system memory 16, which may include both read only memory (ROM) or flash memory (neither shown), and random access memory (RAM) (not shown), as previously noted. The RAM is generally the main memory into which the operating system and application programs are loaded and typically affords at least 16 megabytes of memory space. The ROM or flash memory may contain, among other code, the Basic Input-Output system (BIOS) which controls basic hardware operation such as the interaction with peripheral components. Application programs resident with information handling system 10 are generally stored on and accessed via a computer readable medium, such as a hard disk drive (e.g., fixed disk 44), an optical drive (e.g., optical disk drive 40), floppy disk unit 36 or other storage medium. Additionally, application programs may be in the form of electronic signals modulated in accordance with the application and data communication technology when accessed via network modem 47 or interface 48.

Storage interface 34, as with the other storage interfaces of information handling system 10, may connect to a standard computer readable medium for storage and/or retrieval of information, such as a fixed disk drive 44. Fixed disk drive 44 may be a part of information handling system 10 or may be separate and accessed through other interface systems. Many other devices can be connected such as a mouse 46 connected to bus 12 via serial port 28, a modem 47 connected to bus 12 via serial port 30 and a network interface 48 connected directly to bus 12. Modem 47 may provide a direct connection to a remote server via a telephone link or to the Internet via an internet service provider (ISP). Network interface 48 may provide a direct connection to a remote server via a direct network link to the Internet via a POP (point of presence). Network interface 48 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., bar code readers, document scanners, digital cameras and so on). Conversely, it is not necessary for all of the devices shown in FIG. 1 to be present to practice the present invention. The devices and subsystems may be interconnected in different ways from that shown in FIG. 1. The operation of an information handling system such as that shown in FIG. 1, have known components in a configuration readily known in the art and is not discussed in detail in this application. Code to implement the present invention may be stored in computer-readable storage media such as one or more of system memory 16, fixed disk 44, optical disk 42, or floppy disk 38. Additionally, information handling system 10 may be any kind of computing device, and so includes a personal data assistants (PDA), network appliance, X-window terminal or other such computing device. The operating system provided on information handling system 10 may be MS-DOS®, MS-WINDOWS®, OS/2®, UNIX®, LINUX® or other known operating system. Information handling system 10 also may support a number of Internet access tools, including, for example, an HTTP-compliant web browser having a JavaScript interpreter, such as Netscape Corporation's NAVIGATOR®, Microsoft Corporation's INTERNET EXPLORER® and the like.

The present invention allows information presented to a user of information handling system 10 to be customized according to the user's interests. As mentioned previously, the user profile can be represented within a coordinate system and its position updated to reflect the user's evolving interests.

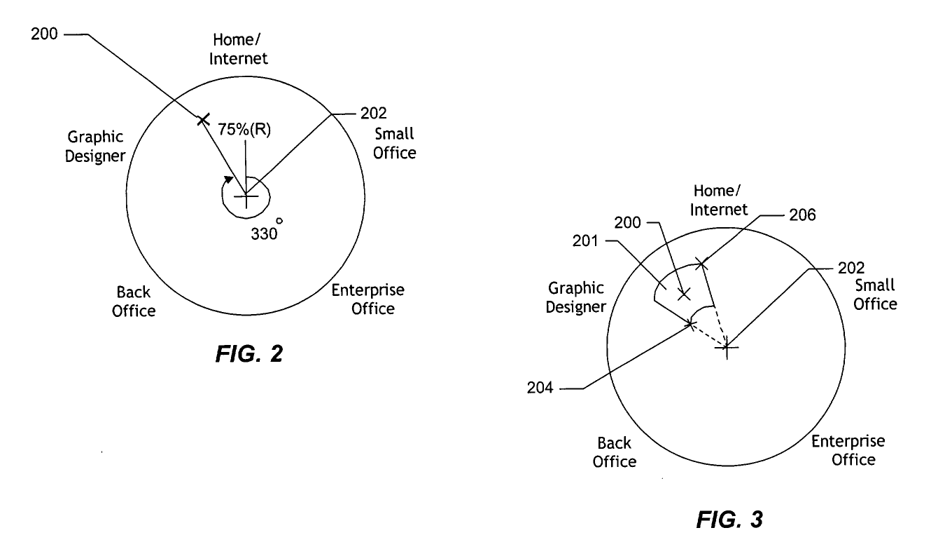

One way to model a user profile in a coordinate system is to use polar coordinates (i.e., n=2) and define the categories of interest using a circle. FIG. 2 illustrates one such example that a web business selling computers might use in representing the customer categories on a circle. Points around the circle are labeled with specific topics of interest. In an alternative embodiment, topics of interest may be defined as points within the circle. Each category can be assigned a weight, and the customer's relative position calculated using the weights.

Referring to FIG. 2, the center of the circle is identified by point 202, and the circle has a radius=R. The point X, bearing reference numeral 200, provides an example classification of a customer within this spectrum. In this particular example, the user's profile is close to the “Home/Internet” category, but tending towards the performance and graphic needs of a “Graphic Designer.” This example shows one possible classification of a customer interested in buying a personal computer to play video games. Additionally, this customer's closeness to the edge of the circle can be equated to the strength of this particular profile. The position of this user's profile is not so close to the edge to suggest that the user is interested only in video games, but rather suggests that the user plans to use the computer for software applications other than games.

To establish, update, and use such a customer profile, this unique profile is associated with the particular user through information, such as a cookie, that is sent by the client with every request to the server. This information can be used to identify content possibly of interest to the user as well as to update the user profile based on the new request for information.

For a two-dimensional space, (i.e., n=2), the method of the present invention uses a circle, an angle and a distance to identify the location X 200 on the circle. The distance from the center of the circle to the edge can be expressed as a percentage of the radius, where 0% is at the center 202 and 100% is on the perimeter of the circle. Thus, the user profile described by the point X 200 on the circle in FIG. 2 can be expressed as an angle having 330°, representing the direction in which the user profile coordinates are placed from the center, and a distance equal to 75% of the outer radius of the circle.

Those skilled in the art will recognize that the use of a coordinate system such as a circle to specify a user profile can be applied to any spectrum of interest. For example, a particular business, such as a bookstore, may have many different categories of interest, such as fiction, non-fiction, and science fiction. The bookstore can represent each of these categories as a single circle and thus the user or customer may have user profiles for each one of these general categories. Although alternate coordinate systems can be used, such as a Cartesian coordinate system, the circular coordinate system is preferred.

The user profile within a two-dimensional space can easily be encoded using as little as 16 bits of information. Thus, one possible allocation of the bits would be to use 9 bits for direction, providing 512 possible angle values (covering the range from 1° to 360°), and 7 bits for the distance, which provides 128 possible percentages of the total distance. The distance is calculated using the equation D=D/127, which provides the percentage of the distance from the center to the edge of the circle. The angle theta can be determined by the equation

$$θ = \frac{D * 360}{512} .$$

Those skilled in the art will also recognize that the angle and distance parameters need not be encoded and may be transmitted as absolute numbers.

As previously discussed in conjunction with the use of cookies, the method of the present invention transmits user profile information with every client request submitted by the user. Alternatively, user profile information may be propagated as a parameter in a URL request. Propagating the information as part of a URL request may be beneficial in situations where an “e-mail this page to a friend” link is used. With customized content depending upon the user profile, the request for the page to be e-mailed may provide reference to the sending user's profile, so that the person receiving the page views the same content as the person originating the e-mail. The recipient sees the web page with the sending user's profile rather than his or her own profile. Another possible situation in which the profile may be propagated as part of a URL request is where the user has disabled the use of cookies. This scenario is less likely, however, as many web sites require that cookies be enabled to function.

When the server receives the profile along with the request for content from the client, the server interprets the customer profile to personalize the content for that user. With respect to FIG. 3, the web content to be provided to a user with a profile identified by point X 200 can be defined by a segment of the circle which includes the point X 200 as the center of a segment 201 defined by two angle-and-distance pairs defined by points 204 and 206 from reference point 202. For an n-dimensional space with n>2, an area of the n-dimensional space can correspond to the content for the target category.

Those skilled in the art will also recognize that this technique can be used to identify or to logically exclude content whenever a user's profile falls between points 204 and 206 (e.g., within segment 201). Thus, a logical comparison operation can be performed on all of the content available for a particular web page. Only that content which is identified to be appropriate for a profile falling within a particular segment is provided to the user.

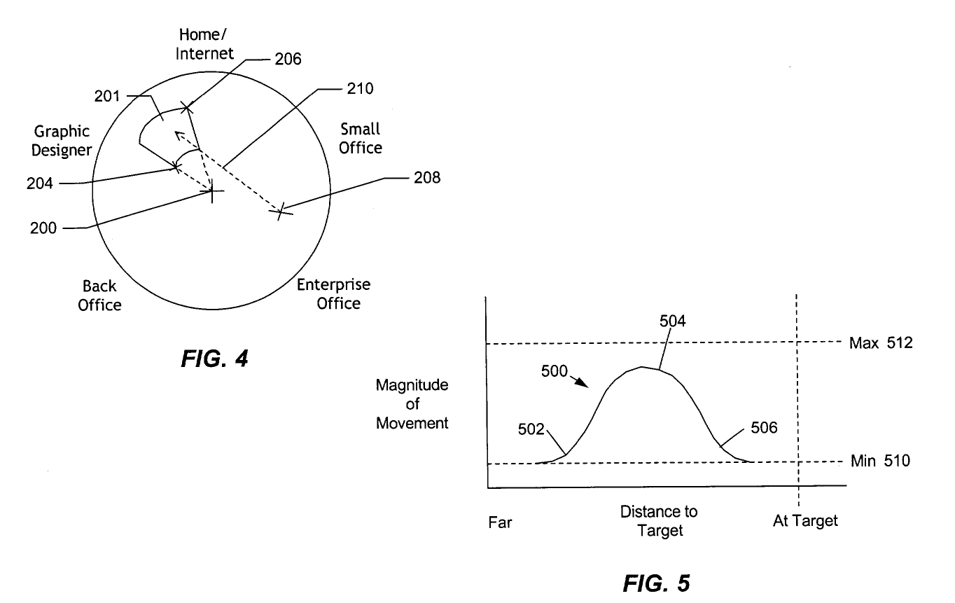

Upon servicing a request for content, the server can also update the user's profile based on the new content requested. With reference to FIG. 4, suppose that the user's current profile is located at point 208. The user issues a request for content that is located in segment 201 of the circle, as defined by points 204 and 206 at a distance 210 as illustrated in FIG. 4.

In this case, the user has requested content that is significantly different from the category in which the user's profile currently resides. Because of this new request, the user profile is updated to reflect the change in content interest expressed by the user's new request. The user's profile should move, but not entirely into the new area. Otherwise, the user profile would present problems similar to those described with reference to profiling techniques defining only rigid customer categories.

The method of the present invention employs a formula for moving or updating the customer profile that uses the overall distance between the customer's current profile and the point in the spectrum of interest in which the new product interest lies. Further, the method of the present invention considers the focus of the information requested. The degree of focus is measured by the size of the segment in which the content falls. For example, when a user clicks on a link on a web site related to a copyright policy for the web site, the information presented by the link may be unrelated to the products in which the user is interested. Therefore, the copyright information may be considered to be broadly applicable to all products, and thus to fall within a very broad segment. Alternatively, when a user clicks on a link to detailed product information, the segment may be too narrowly focused on the specific product for which the detailed information is presented. Such a segment has a relatively smaller size when compared to a broad segment.

FIG. 5 illustrates one embodiment of a function that may be used to determine movement of a user profile when information in a new interest area is requested. This change is expressed as a distance and direction in which the profile moves within the spectrum of interest toward a target representing the new interest area. The function is used to introduce user profile changes gradually rather than immediately upon a request for a different type of content.

The target can be calculated to correspond to a center point of a segment of the circle, where the segment represents the new interest area. Each movement toward the target can be calculated, for example, using a weight determined from the size of the segment in which the target point resides. The weight reflects whether the segment is broadly or narrowly focused and therefore adjusts according to the likelihood that the movement will produce relevant content.

In accordance with the function of FIG. 5, when the current profile is far from the target profile, the distance moved is minimal, as illustrated by the magnitude of the far portion 502 of the curve 500. As the current profile moves closer to the target profile, the distance moved toward the target increases to a certain point 504 and then slows down again (506) as the points become close. The minimum 510 and maximum 512 distances are determined by the size of the segment defining the content. For a small segment indicating highly focused content, a request from a farther distance is more likely to produce relevant content than an equal distance within a larger segment having less-focused content. Ideally, the minimum and maximum values range between 10-60%, although establishing minimum and maximum values is not required to practice the invention. Restricting the range of values avoids a sudden change in the type of content presented to the user. The amount of movement that a click makes is typically a factor of, for example: a) the distance from the current point to the target point; and b) the size of the target segment, meaning that the user would move faster towards smaller segments that correspond to more focused content. Other factors can be used to modify the amount of movement that a click makes. Similarly, different curves 500 can be used to tailor movement in certain situations. For example, in some situations, a symmetric or an asymmetric bell curve may be desirable instead of the curve 500. Still other curve shapes may prove beneficial in different situations and the use of alternate curves 500 are encompassed by the present invention.

An alternative to using a function, such as the one shown in FIG. 5, is to use the angle, the distance of the target point, and a weight (expressed as a percentage) that dictates the amount of movement. The curve for such a function is not a symmetrical bell-shaped curve because the closer the user profile moves to the target, the smaller is the distance of which a percentage is taken.

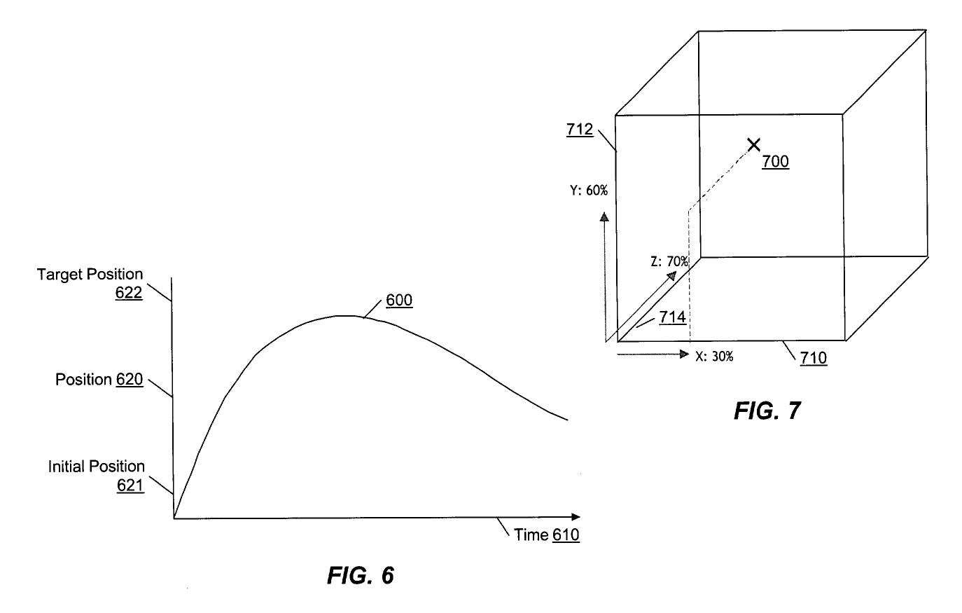

FIG. 6 provides a graph of the relative position of the user profile as it moves from an initial position over time. This graph represents the relative position for a session in which a user continues to select content more closely related to the target than to content associated with the initial position. Referring to FIG. 6, the curve 600 plots position 620 as a function of time 610, going from the initial position 621 to the target position 622 as illustrated in FIG. 6.

FIG. 7 shows a user profile positioned at a location X 700 identified by coordinates X, Y and Z in a three-dimensional space. Point x is located at 30% of the length of the x axis 710, pointy is at 60% on the y axis 712, and point z is at 70% on the z axis 714. Using this technique, a particular user profile can be placed within the relevant categories by storing a set of n coordinates. This technique requires much less storage space than that needed to store data for each subcategory.

Within the n-dimensional space, the axes themselves may have no meaning. As with the circle embodiment defined above, points within the n-dimensional space may be assigned to categories. The position of the user profile in relation to the center point of the category can be used to calculate a score for that category. By scoring a user's interest in each category, a bar graph of scores can be constructed to provide a snapshot of the user's interests.

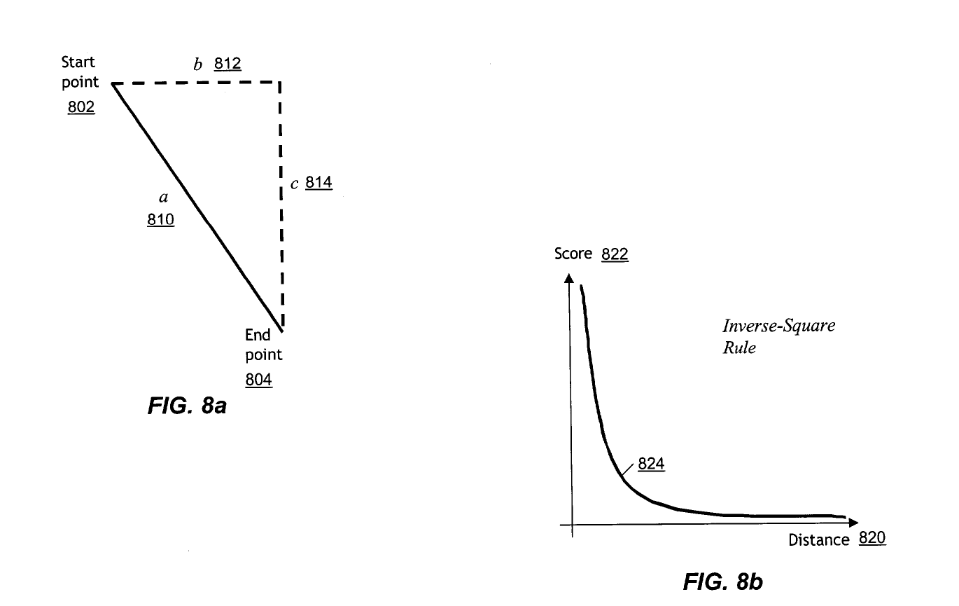

FIG. 8a shows an example of an implementation for determining a new location of a user profile for a particular user when the user has selected content falling into a category outside the category into which the user's profile currently falls. In this example, a point-to-point distance calculation is made. Assume that the user's profile is currently located at start point 802 and selects content located at end point 804. The distance to move is easily calculated using Pythagoras' Theorem, a²=b²+c², wherein a, b and c correspond to the lengths of line segment a 810, line segment b 812, and line segment c 814.

Using the distance a for line segment a 810, a score can be calculated as a linear function to reflect linear degradation over distance. Alternatively, a non-linear scaling factor such as the inverse-square rule may be used to decrease strength quickly as the user's selection of content moves away from the initial category.

FIG. 8b shows an example using a non-linear scaling factor for determining a new location of a user profile for a particular user when the user has selected a category outside the current user profile category. The inverse-square rule uses the formula a=1/r², to derive curve 824 where a is the attraction felt (that is, the score 822 applied), and r is the distance 820 between the starting point and the ending point. The inverse-square rule is used, for example, to model the strength of forces such as gravity and electromagnetic radiation as they move away from the source. For example, as the distance between two points is halved, the strength of the attraction is increased by a factor of four. The application of the inverse-square rule to the present invention leads to the inverse-square approach for the scaling factor.

The inverse-square approach may use parameters to affect the gradient of the curve. For example, the exponent may be used as a parameter: a=1/r^{e}, where the exponent e has a value greater than zero. For example, an exponent of 1 causes a straight-line relationship between score and distance, and an exponent between 0 and 1 causes the curve to bow in the opposite direction from the bow of function 824.

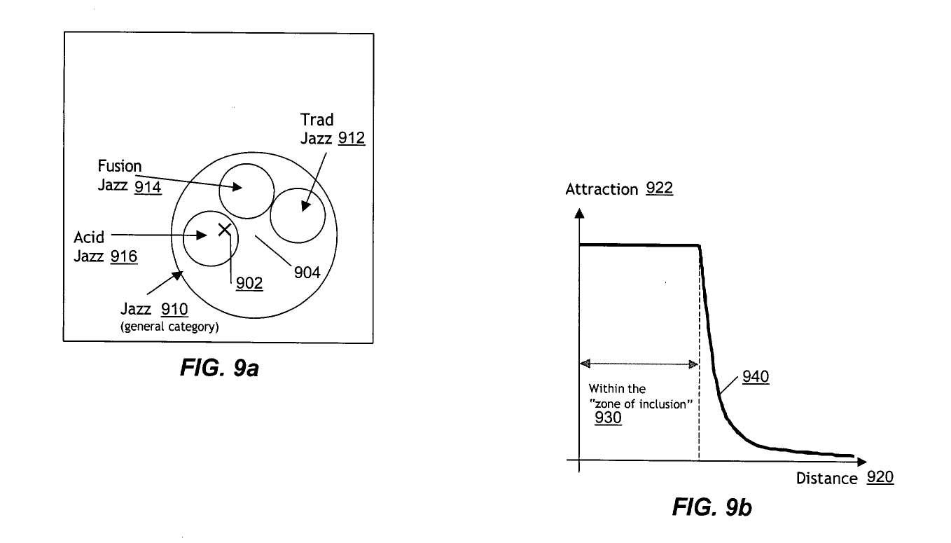

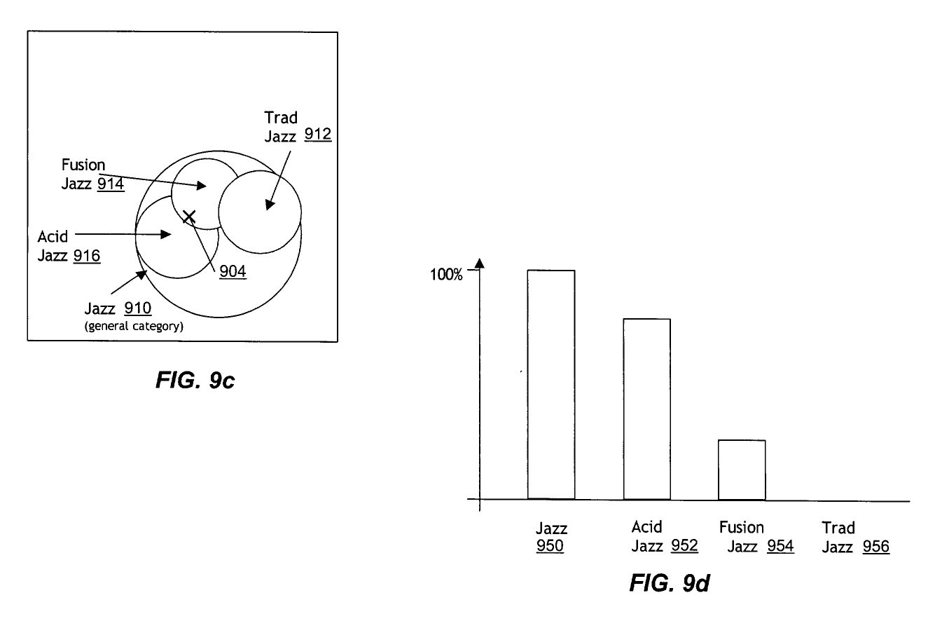

FIG. 9a shows an alternative “zone of inclusion” approach for determining a new location of a user profile for a particular user when the user has selected a category outside the user's current category. Using the “zone of inclusion” approach, the category is still centered on a central point (i.e., the center 904 of the jazz circle 910), but there is a space around it a fixed distance from the center, represented by the perimeter of jazz circle 910. If the user's profile 902 is within this space, the user is considered to be interested in content for that category; otherwise, the user is not. The zone of inclusion approach thus provides a binary score, such as 1 or 0, true or false, or 100% or 0%.

The binary nature of this approach works well for blanket categories. For example, jazz category 910 includes all subcategories of jazz. If a user's profile 902 is within one of the jazz subcategories such as traditional jazz 912, fusion jazz 914, or acid jazz 916, the user is considered to be within the zone of inclusion of the jazz category 910, even though the user's profile may be far from the center 904 of jazz circle 910. In the example of FIG. 9a, the user profile 902 is within the acid jazz subcategory 916, which is still within the broader jazz category 910.

FIG. 9b illustrates another embodiment having a combination of the zone of inclusion approach and the inverse-square rule used to determine a new location of a user profile for a particular user when the user has selected content related to a category outside the category including the user profile's initial position. In FIG. 9b, the x axis represents the distance 920 that the user profile is moved, and the y axis represents the attraction 922 to the zone of inclusion 930. The combination produces the curve 940, which reflects the user's placement within the zone of inclusion 930 in the flat portion of the curve, but also allows the user profile to indicate interest in other categories. Furthermore, by allowing an exponent to be associated with each category, the degree of “fade” is controlled. The degree of fade corresponds to the “speed of movement” of the score as the score fades away from 100% when the user profile moves outside the zone of inclusion 930.

Referring to the example embodiment illustrated in FIG. 9c, the three jazz subcategories of FIG. 9a (traditional jazz 912, fusion jazz 914, and acid jazz 916) are shown. From user profile's position 904, the user's interests lie near the center of the subcategory acid jazz 916, but also indicate some interest in the subcategory fusion jazz 914.

FIG. 9d shows scores that have been calculated for the user profile shown in FIG. 9c. As noted above, scores can be calculated for each category. Assume that the method for calculating distance combines a zone of inclusion with a fade parameter, produced by the inverse-square rule, in addition to the zone of inclusion. Considering the example user profile 904 of FIG. 9c, a score of 100% indicates that the user's interests lie within jazz category 950. Acid jazz subcategory 952 shows a 75% score, and fusion jazz subcategory 954 shows a 25% score, reflecting the user's interests in both acid and fusion jazz music. Traditional jazz subcategory 956 shows that the user has indicated no interest in traditional jazz music.

Having scored the individual categories, the user profile can be used to show customer music offerings from artists that fit this scoring profile; i.e., artists with a strong acid jazz content, but some fusion jazz influence.

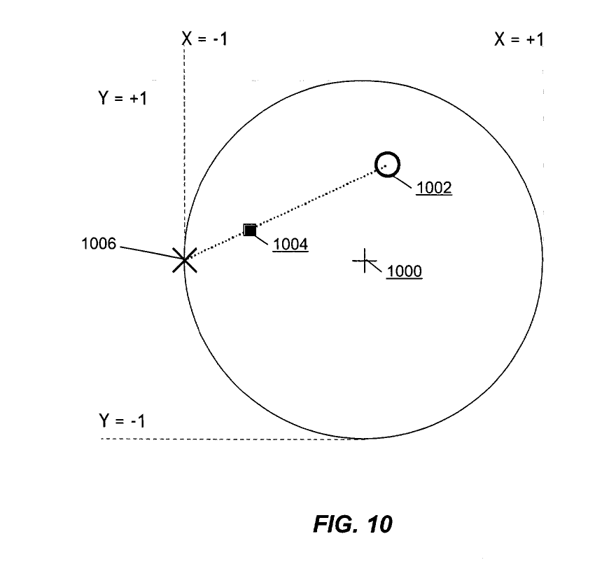

FIG. 10 illustrates a technique for calculating distance that a user profile is to be shifted between a starting point and an ending point. The movement of the user's profile is calculated by determining a target point from the content the customer is viewing. The distance to be moved can then be calculated as a fraction of the distance between the starting point and the target point.

Each target point may be associated with a weight, such as the length of the distance between the starting and target points. Alternatively, each target point may be associated with a predetermined weight, such as 20%. For both alternatives, the amount of distance that the user's profile moves is a fraction of the intervening distance, so that the distance that the user profile is moved is reduced as you approach the target.

To calculate the new location of the user profile, a starting and target point for each axis may be determined. The distance between the two points, as calculated according to a function such as the inverse-square rule, can be multiplied by the weight (as a percentage). If the target point is at a lower value on the axis than the starting point, the resulting distance value will be negative. The starting point may then be added to the distance calculated to determine the new user profile position on that axis.

FIG. 10 shows an example calculation of a new position for a user profile in a polar coordinate system (i.e., n=2). In this example, each of the physical x and y coordinates has a value in the range from −1 to +1. For example, starting point 1006 on the edge of the circle corresponds to a position where x=−1 and y=0. Target point 1002 lies within the category represented by the circle around center point 1000.

From starting point 1006, the intervening distance to the target point 1002 is measured using a method as described above to calculate the new user profile point 1004. For example, the following formula can be used:

X′=X₁+((X₂−X₁)*w)

where

X′ corresponds to the new location of the user profile at point 1004,

X₁ corresponds to the starting point 1006,

X₂ corresponds to the target point 1002, and

w corresponds to a weight associated with the category represented by the circle surrounding center point 1000.

Using the new location of the user profile at point 1004, the angle and distance from the center of the circle 1000 is calculated. The distance is easily calculated using, for example, Pythagoras' Theorem from the x and y coordinates of the new position:

distance=²\sqrt{x²+y²}

. . . and the new angle can be calculated as:

$$angle = ArcTangent ( \frac{y}{x} )$$

The angle calculated as above may need to be converted from radians to degrees, depending upon the implementation. Moreover, higher order, i.e., n^{th} roots may be used in the equation to modify the results.

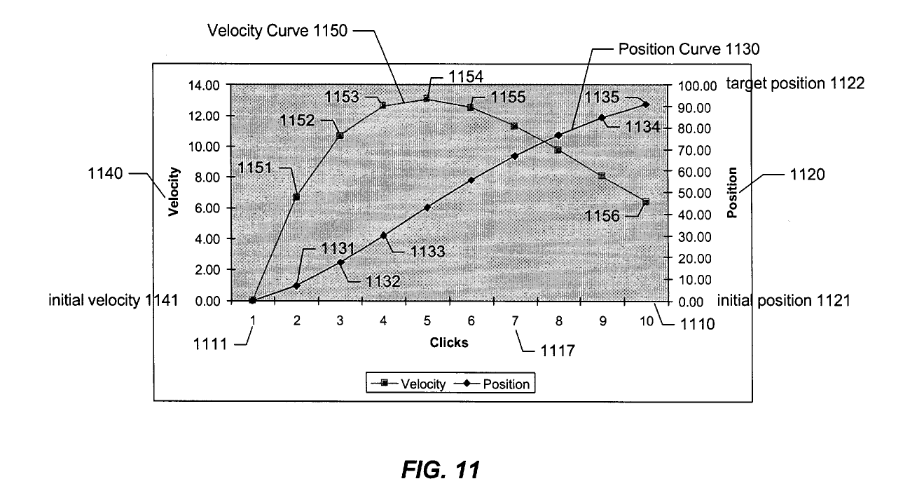

FIG. 11 shows a graph of position of the user profile with consecutive clicks on links of a web page corresponding to a target category. Superimposed is a graph of the velocity of the movement of the user profile with consecutive clicks. For purposes of the table shown below, “current velocity” means “how far is the user going to move with the next click. “Implied velocity” is the percentage of the remaining distance that is covered in the next hop. “True velocity” is a weighted average of the implied velocity and the current velocity. The use of the various velocity terms is used, for example, to obtain a bell curve 500, and to prevent rapid changes in velocity that might lead to unexpected or inappropriate changes in present content. Typically, the user's profile is tracked over multiple uses of the web site, so that the 10 clicks might occur over a period of weeks, or they may occur within a single session. Thus, the time component in the velocity terms is preferably a function of the number of clicks, rather than a calendar period, although other determining functions could be used. Each of the graphs corresponds to data for a particular example, described here and in Table 1 below.

TABLE 1

| click | | | remaining | implied | |
|---|---|---|---|---|---|
| number | position | current velocity | distance | velocity | true velocity |
| 1 | 0.00 | 0.00 | 100.00 | 20.00 | 6.67 |
| 2 | 6.67 | 6.67 | 93.33 | 18.67 | 10.67 |
| 3 | 17.33 | 10.67 | 82.67 | 16.53 | 12.62 |
| 4 | 29.96 | 12.62 | 70.04 | 14.01 | 13.08 |
| 5 | 43.04 | 13.08 | 56.96 | 11.39 | 12.52 |
| 6 | 55.56 | 12.52 | 44.44 | 8.89 | 11.31 |
| 7 | 66.87 | 11.31 | 33.13 | 6.63 | 9.75 |
| 8 | 76.62 | 9.75 | 23.38 | 4.68 | 8.06 |
| 9 | 84.68 | 8.06 | 15.32 | 3.06 | 6.39 |
| 10 | 91.07 | 6.39 | 8.93 | 1.79 | 4.86 |

Factor = 20%
Current Multiplier = 2
Implied Multiplier = 1

Table 1 and FIG. 11 show the position and movement of the user profile throughout a series of ten clicks in the target category in a two-dimensional space. Each click corresponds to a row of Table 1 and a point on the Clicks axis 1110 of FIG. 11. For example, point 1111 corresponds to the first click and point 1117 corresponds to the seventh click within the target category. Velocity of the movement of the user profile is shown by Velocity curve 1150 using the Velocity axis 1140. The Velocity curve 1150 corresponds to the “current velocity” column of Table 1 and has intermediate points 1151, 1152, 1153, 1154, 1155, and 1156. The position of the user profile as it moves according to the velocity calculated is shown by Position curve 1130 using the Position axis 1120. The Position curve 1130 corresponds to the “position” column of Table 1 and has intermediate points 1131, 1132, 1133, 1134, and 1135.

In this example, a fixed factor of 33% is used to calculate movement from the current position of the user profile in the direction of the target category. In other embodiments, a variable factor determined by the relevance of the information requested within the target category can be used. For example, in one embodiment, the factor can be determined using the size of the area of the target category corresponding to a link upon which the user clicks.

In FIG. 11 and Table 1 row 1, the current user profile is placed at position 0. In FIG. 11, the initial position on Position axis 1120 is at initial position 1121, and the target position is set at position 100 units, corresponding to target position 1122. A total distance of 100 units lies between the user profile position and the target position. Note that the number of units can be set arbitrarily for simple calculation of the amount of movement of the user profile within the n-dimensional space. The user profile is positioned at position 0 units until the user clicks to request a new type of content, such as content within the target category. Until that time, the initial velocity 1141 of the movement is 0, and the remaining distance is 100.

Initial values in Table 1 row 1 are calculated using the following formulae:

$$\begin{matrix}Implied Velocity = Remaining Distance * Factor \\ = 100 * 0.33 = 33 \\ True Velocity = ( ( 2 * Current Velocity ) + Implied Velocity ) / 3 \\ = ( ( 2 * 0 ) + 33 ) / 3 = 11\end{matrix}$$

After each click, the new position of the user profile is calculated as the minimum value of the total distance AND the sum of the position of the previous row and the true velocity of the previous row, as shown below for Table 1 rows 2-4.

$$\begin{matrix}Position = MIN ( Total Distance , \\ SUM ( Previous Position , Previous True Velocity ) ) \\ = MIN ( 100 , 0 + 11 ) = 11 ( Row 2 , Figure 11 point 1131 ) \\ = MIN ( 100 , 11 + 19.69 ) \\ = 30.69 ( Row 3 , Figure 11 point 1132 ) \\ = MIN ( 100 , 30.69 + 20.94 ) \\ = 51.62 ( Row 4 , Figure 11 point 1133 )\end{matrix}$$

and

Distance=²\sqrt{(x₂−x₁)²+(y₂−y₁)²}

As shown by Position curve 1130 of FIG. 11, point 1131 corresponds to a position value of 11 from Table 1 row 2. Point 1132 corresponds to a position value of 30.69 from Table 1 row 3; point 1133 corresponds to a position value of 51.62 from Table 1 row 4; point 1134 corresponds to a position value of 98.16 from Table 1 row 8; and point 1135 corresponds to a position value of 100 from Table 1 row 9. The new current velocity for row 2 is calculated to have a value of 10.

The remaining distance is calculated by subtracting the current position from the remaining distance of the previous row. This calculation is used to provide the following values in Table 1 rows 2 through 4:

$$\begin{matrix}Remaining distance = 100 - 11 = 89 ( Row 2 ) \\ = 89 - 19.69 = 69.32 ( Row 3 ) \\ = 69.32 - 20.94 = 48.38 ( Row 4 ) \\ Implied Velocity = 89 * .33 = 29.37 ( Row 2 ) \\ = 69.32 * .33 = 22.87 ( Row 3 ) \\ = 48.38 * .33 = 15.96 ( Row 4 ) \\ True Velocity = Average of Current Velocity and \\ Implied Velocity ?? ? \\ = ( 10 + 29.37 ) / 2 = 19.69 ( Row 2 ) \\ = ( 19 + 22.87 ) / 2 = 20.94 ( Row 3 ) \\ = ( 20 + 15.96 ) / 2 = 17.98 ( Row 4 )\end{matrix}$$

As shown in Velocity curve 1140, point 1152 corresponds to the true velocity value of 19.69 after the third click. Velocity curve 1140 peaks at point 1153, where true velocity is 20.94 after the fourth click. After this point, the user profile has moved over half of the distance (51.62 units) between the initial position of 0 and the target position of 100, as shown on Position curve 1130 at point 1133.

One of skill in the art will recognize that the methods for establishing and adjusting a user profile of interests can be implemented using an information handling system such as that of FIG. 1.

The advantages of the present invention provide a user profiling method and system that are automated and require only minimal information from the user. The user profiling method and system store and update data reflecting the user's interests concisely as a small amount of data. A controlled transition between categories is made when the user requests information related to a different category than the user profile category. The method and system also recognizes user profiles that overlap or fall between defined categories and presents related content information accordingly. The user profiling method and system can be applied to any spectrum of interests.

Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The foregoing described embodiments shows different components contained within other components (e.g., the various elements shown as components of information handling system 10). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

The foregoing detailed description has set forth various embodiments of the present invention via the use of block diagrams, flowcharts, and examples. It will be understood by those within the art that each block diagram component, flowchart step, operation and/or component illustrated by the use of examples can be implemented, individually and/or collectively, by a wide range of hardware, software, firmware, or any combination thereof.

The present invention has been described in the context of a fully functional information handling system; however, those skilled in the art will appreciate that the present invention is capable of being distributed as a program product in a variety of forms, and that the present invention applies equally regardless of the particular type of signal bearing media used to actually carry out the distribution. Examples of signal bearing media include recordable media such as floppy disks and CD-ROM, transmission type media such as digital and analog communications links, as well as media storage and distribution systems developed in the future.

The above-discussed embodiments may be implemented by software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the spirit and scope of the invention.

The invention, therefor, is well adapted to carry out the objects and to attain the ends and advantages mentioned, as well as others inherent therein. While the invention has been depicted, described and is defined by reference to exemplary embodiments of the invention, such references do not imply a limitation on the invention, and no such limitation is to be inferred. The invention is capable of considerable modification, alternation and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is to be limited only by the spirit and scope of the appended claims, giving full cognizance to equivalents in all respects.

What is claimed:

1. A method for presenting information to a user, the method comprising:
establishing a first user profile for the user within a plurality of categories of interests, the first user profile corresponding to a first category of the categories;
dynamically using the first category and first information requested by the user to determine a second category of the categories that interests the user;
adjusting the first customer profile to produce a second customer profile for the user using the first category and the second category; and
presenting to the user the first information and third information corresponding to a third category of the categories, the presenting using the second 11 customer profile.

2. The method of claim 1 wherein
the third category falls between the first category and the second category.

3. The method of claim 1 wherein
the third category and the first category are the same.

4. The method of claim 1 wherein
the third category and the second category are the same.

5. The method of claim 1 wherein the adjusting comprises:
moving the first user profile toward the second category.

6. A method for presenting information to a user, the method comprising:
establishing a first user profile for the user within a plurality of categories of interests, wherein
a first user profile corresponds to a first category of the categories,
the first category corresponds to a first area of an n-dimensional space, and
the first user profile corresponds to a first set of n coordinates in the n-dimensional space;
dynamically using the first category for determining a second category of the categories that interests the user according to first information requested by the user, wherein
the second category corresponds to a second area of the n-dimensional space, and
the second user profile corresponds to a second set of n coordinates in the n-dimensional space;
adjusting the first customer profile to produce a second customer profile for the user using the first category and the second category, wherein
the second customer profile corresponds to a second set of n coordinates in the n-dimensional space; and
presenting to the user the first information and third information corresponding to a third category of the categories, wherein
the presenting uses the second customer profile.

7. The method of claim 6 wherein the adjusting comprises:
moving the first user profile toward the second category.

8. A system comprising:
a user profile definition module to establish a first user profile for the user within a plurality of categories of interests, the first user profile corresponding to a first category of the categories;
an interest determining module to dynamically use the first category to determine a second category of the categories that interests the user according to first information requested by the user;
an adjusting module to adjust the first customer profile to produce a second customer profile for the user using the first category and the second category; and
a presentation module to present to the user the first information and third information corresponding to a third category of the categories, wherein
the presenting uses the second customer profile.

9. An information handling system for presenting information to a user comprising:
a processor,
a memory comprising instructions, wherein the processor executes the instructions and the instructions comprise:
user profile definition instructions to establish a first user profile for the user within a plurality of categories of interests, the first user profile corresponding to a first category of the categories;
category determining instructions to dynamically use the first category and first information requested by the user to determine a second category of the categories that interests the user;
adjusting instructions to adjust the first customer profile to produce a second customer profile for the user using the first category and the second category; and
presenting instructions to present to the user the first information and third information corresponding to a third category of the categories, the second customer profile being used to present.
